(19) United States
(12) Patent Application Publication
(10) Pub. No.: US 2019/0214680 A1
(43) Pub. Date: Jul. 11, 2019

(54) LITHIUM ION BATTERY AND ELECTROLYTIC SOLUTON THEREOF

(71) Applicant: NINGDE AMPEREX TECHNOLOGY LIMITED, Ningde City (CN)

(72) Inventors: Xiangkun BO, Ningde City (CN); Shuirong ZHANG, Ningde City (CN); Chao TANG, Ningde City (CN); Juan MA, Ningde City (CN)

(73) Assignee: NINGDE AMPEREX TECHNOLOGY LIMITED

(21) Appl. No.: 16/131,317

(22) Filed: Sep. 14, 2018

(30) Foreign Application Priority Data
Jan. 5, 2018 (CN) 201810011702.8

(51) Int. Cl. H01M 10/0567; H01M 10/0525

(52) U.S. Cl. CPC H01M 10/0567; H01M 4/386; H01M 2300/004; H01M 10/0525

(57) ABSTRACT

The present application provides an electrolytic solution, comprising:
a carbonate compound of the formula (I),

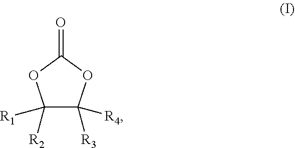

wherein R₁, R₂, R₃ and R₄ are each independently selected from hydrogen or halogen, and at least one of R₁, R₂, R₃ and R₄ is halogen;
a carbonate compound of the formula (II),

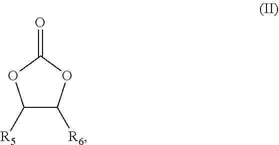

wherein R₅ and R₆ are each independently selected from hydrogen, halogen, (C₁-C₁₀)alkyl, (C₁-C₁₀)haloalkyl, (C₁-C₁₀)alkoxy or (C₁-C₁₀)haloalkoxy, and at least one of R₅ and R₆ is (C₁-C₁₀)haloalkyl or (C₁-C₁₀)haloalkoxy; and
a nitrile compound, the nitrile compound being selected from the group consisting of a dinitrile compound of the formula (III), a dinitrile compound of the formula (IV), a trinitrile compound of the formula (V), and a combination thereof:

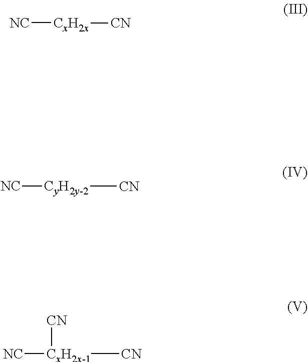

where x is a positive integer from 1 to 10, and y is a positive integer from 2 to 10.

### BACKGROUND

### 1. Technical Field

The present application relates to a lithium ion battery and an electrolytic solution thereof.

### 2. Description of the Related Art

Lithium ion batteries have wide applications in the field of consumer batteries such as unmanned aerial vehicles, mobile phones, computers and the like and the field of new energy electric vehicles because of their high energy density, high output voltage, long cycle life, low environmental pollution, no memory effect, etc. Cycle life is a key parameter for evaluating the performance of the lithium ion batteries. Improving the cycle performance of the lithium ion batteries is a goal that researchers and technicians have been striving for. The cycle life of a lithium ion battery is related to the cathode material, the anode material and the electrolytic solution. In the process of formation, the electrolytic solution forms a stable SEI film on the surface of the anode. The SEI film can prevent the solvent in the electrolytic solution from further contacting the surface of the electrode, and can maintain the structural stability of the anode material, thereby improving the cycle performance of the anode material.

In order to improve the cycle performance and safety performance of lithium ion batteries, in addition to seeking new cathode and anode materials, the development of new electrolytic solution formulae is also an important solution. The non-aqueous electrolytic solution of the lithium ion battery is mainly formed by dissolving an electrolyte in an organic solvent. In addition, the electrolytic solution also contains certain additives for promoting the film formation of the anode, increasing the conductivity of the electrolytic solution, reducing the internal resistance of the battery, improving the storage performance of the battery, improving the cycle performance of the battery, and the like.

### SUMMARY

The technical problem to be solved by the present application is that the cathode and anode materials are prone to breakage and irreversible reaction during the cycle of the lithium ion battery, and the formation of a relatively stable SEI film on the surface of the anode by adding a specific additive to the electrolytic solution can improve the cycle performance of the lithium ion battery. However, a single additive has limited improvement in cycle performance of the battery. Therefore, the combination of additives of specific structures is an effective means to improve the cycle performance of the lithium ion battery. In addition, a nitrile additive can stabilize the cathode material during charging and discharging, which is helpful for improving the storage, floating charge and nail penetration performance of the lithium ion battery.

One object of the present application is to provide an electrolytic solution comprising a carbonate compound of the formula (I), a carbonate compound of the formula (II) and a nitrile compound, wherein:

the carbonate compound of the formula (I) is

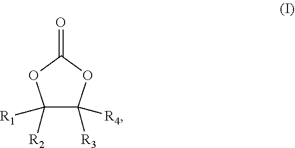

wherein R₁, R₂, R₃ and R₄ are each independently selected from hydrogen or halogen, and at least one of R₁, R₂, R₃ and R₄ is halogen;

the carbonate compound of the formula (II) is

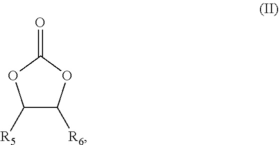

wherein R₅ and R₆ are each independently selected from hydrogen, halogen, (C₁-C₁₀)alkyl, (C₁-C₁₀)haloalkyl, (C₁-C₁₀)alkoxy or (C₁-C₁₀)haloalkoxy, and at least one of R₅ and R₆ is (C₁-C₁₀)haloalkyl or (C₁-C₁₀)haloalkoxy; and

the nitrile compound is selected from the group consisting of a dinitrile compound of the formula (III), a dinitrile compound of the formula (IV), a trinitrile compound of the formula (V), and a combination thereof:

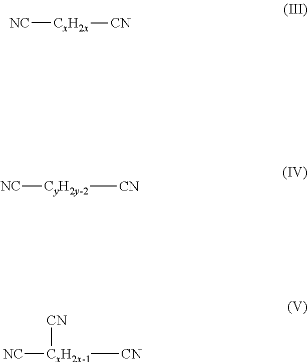

where x is a positive integer from 1 to 10, and y is a positive integer from 2 to 10.

Another object of the present application is to provide a lithium ion battery comprising a cathode material, a separator, an anode material, and an electrolytic solution according to the present application.

Based on the previous work of the present application, it has been found through research and a large number of experiments that mixing and adding the carbonate compound of the formula (I), the carbonate compound of the formula (II) and the specific nitrile compound according to the present application into the electrolytic solution can greatly improve the cycle performance of the lithium ion battery.

### DETAILED DESCRIPTION

In order to make the objects, technical solutions and advantages of the present application more clear, the technical solutions of the present application will be clearly and comprehensively described in the following with reference to the embodiments of the present application. It is apparent that the described embodiments are a part of the embodiments of the present application, rather than all of the embodiments. All other embodiments obtained by those skilled in the art, based on the technical solutions provided by the present application, and without creative effort are all within the scope of the present application.

### Definitions

Unless otherwise expressly indicated, the following terms used herein have the meanings indicated below.

“Alkyl” may be a linear-chain saturated hydrocarbon structure having 1 to 10 carbon atoms, preferably 1 to 8 carbon atoms and more preferably 1 to 6 carbon atoms or 1 to 4 carbon atoms. “Alkyl” may also be a branched-chain or cyclic hydrocarbon structure having 3 to 10 carbon atoms, preferably 3 to 8 carbon atoms and more preferably 3 to 6 carbon atoms. When an alkyl having a specific carbon number is specified, it may encompass all geometric isomers having that carbon number; therefore, for example, “butyl” means to include n-butyl, sec-butyl, isobutyl and tert-butyl; and “propyl” includes n-propyl and isopropyl. Examples of alkyl groups include methyl, ethyl, n-propyl, isopropyl, n-butyl, isobutyl, sec-butyl, tert-butyl, n-pentyl, isopentyl, neopentyl, cyclopentyl, cyclohexyl, n-heptyl, octyl, cyclopentyl, cyclopropyl, cyclobutyl, norbornyl and the like.

“Halogen” refers to fluorine, chlorine, bromine or iodine.

“Alkoxy” refers to an alkyl attached to a parent structure through an oxygen atom (—O-alkyl). When a cycloalkyl is attached to a parent structure through an oxygen atom, the group may also be referred to as a cycloalkoxy. Examples include methoxy, ethoxy, propoxy, isopropoxy, cyclopropoxy, butoxy, sec-butoxy, tert-butoxy, pentyloxy, cyclohexyloxy and the like. “Perhaloalkoxy” may be a perhaloalkyl attached to the parent structure through oxygen, such as the group —O—CF₃.

Hereinafter, embodiments of the present application will be described in detail.

First, the electrolytic solution of the first aspect of the present application will be described.

The electrolytic solution according to the present application comprises: a carbonate compound of the formula (I)

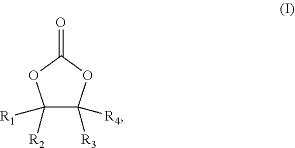

wherein R₁, R₂, R₃ and R₄ are each independently selected from hydrogen or halogen, and at least one of R₁, R₂, R₃ and R₄ is halogen;

a carbonate compound of the formula (II)

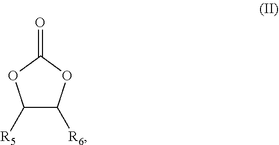

wherein R₅ and R₆ are each independently selected from hydrogen, halogen, (C₁-C₁₀)alkyl, (C₁-C₁₀)haloalkyl, (C₁-C₁₀)alkoxy or (C₁-C₁₀)haloalkoxy, and at least one of R₅ and R₆ is (C₁-C₁₀)haloalkyl or (C₁-C₁₀)haloalkoxy; and

a nitrile compound, the nitrile compound being selected from the group consisting of a dinitrile compound of the formula (III), a dinitrile compound of the formula (IV), a trinitrile compound of the formula (V), and a combination thereof:

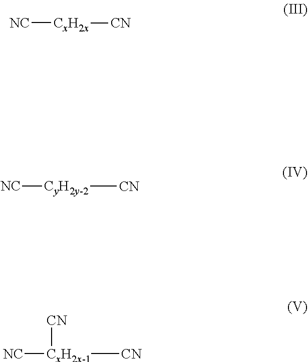

where x is a positive integer from 1 to 10, and y is a positive integer from 2 to 10.

According to an embodiment of the present application, the carbonate compound of the formula (I) is at least one of the following compounds: fluoroethylene carbonate (FEC), 4,5-difluoroethylene carbonate (DFEC) and 4,4,5,5-tetrafluoroethylene carbonate (TFEC).

According to another embodiment of the present application, the content of the carbonate compound of the formula (I) is about 0.1 wt % to about 30 wt % based on the total weight of the electrolytic solution. Preferably, the content of the carbonate compound of the formula (I) of the present application is about 0.5 wt % to about 25 wt % based on the total weight of the electrolytic solution. Further preferably, the content of the carbonate compound of the formula (I) of the present application is about 0.5 wt % to about 20 wt % based on the total weight of the electrolytic solution.

According to an embodiment of the present application, in the carbonate compound of the formula (II), R₅ is hydrogen, halogen, (C₁-C₅)alkyl or (C₁-C₈)haloalkyl; R₆ is hydrogen, halogen, (C₁-C₅)alkyl, (C₁-C₅)haloalkyl or (C₁-C₈)haloalkoxy, and at least one of R₅ and R₆ is (C₁-C₅)haloalkyl or (C₁-C₈)haloalkoxy.

According to another embodiment of the present application, in the carbonate compound of the formula (II), R₅ is hydrogen, fluorine, (C₁-C₆)alkyl or (C₁-C₆)fluoroalkyl; R₆ is hydrogen, fluorine, (C₁-C₆)alkyl, (C₁-C₆)fluoroalkyl or (C₁-C₆)fluoroalkoxy, and at least one of R₅ and R₆ is (C₁-C₆)fluoroalkyl or (C₁-C₆)fluoroalkoxy.

According to another embodiment of the present application, in the carbonate compound of the formula (II), R₅ is hydrogen, fluorine, (C₁-C₆)alkyl or (C₁-C₆)fluoroalkyl; and R₆ is (C₁-C₆)fluoroalkyl or (C₁-C₆)fluoroalkoxy.

According to another embodiment of the present application, in the carbonate compound of the formula (II), R₅ is hydrogen, fluorine, (C₁-C₄)alkyl or (C₁-C₄)fluoroalkyl; and R₆ is (C₁-C₄)fluoroalkyl or (C₁-C₄)fluoroalkoxy.

According to still another embodiment of the present application, in the carbonate compound of the formula (II), R₅ is selected from H, F, —CH₃, —CH₂F, —CHF₂, —CF₃, —CH₂CF₃, —CHFCF₃, —CF₂CH₂F, —CF₂CHF₂, —CF₂CF₃, —CF₂CF₂CF₃, —CF₂CF₃—CH₂CH₂CH₂F or —CH₂CH₂CHF₂; and R₆ is selected from —CH₂F, —CHF₂, —CF₃, —CH₂CF₃, —CHFCF₃, —CF₂CH₂F, —CF₂CHF₂, —CF₂CF₃, —CH₂CH₂CH₂F, —CH₂CH₂CHF₂, —CH₂CH₂CF₃, —CH₂CHFCH₃, —CH₂CHFCH₂F, —CH₂CHFCHF₂, —CH₂CHFCF₃, —CH₂CF₂CH₃, —CH₂CF₂CH₂F, —CH₂CF₂CHF₂, —CH₂CF₂CF₃, —CHFCF₂CH₂F, —CHFCF₂CHF₂, —CHFCF₂CF₃, —CF₂CF₂CF₃, —CH₂CH₂CH₂CF₃, —CH₂CH₂CHFCH₂F, —CH₂CH₂CHFCHF₂, —CH₂CH₂CHFCF₃, —CH₂CH₂CF₂CH₃, —CH₂CH₂CF₂CH₂F, —CH₂CH₂CF₂CHF₂, —CH₂CH₂CF₂CF₃, —CH₂CHFCF₂CH₃, —CH₂CHFCF₂CH₂F, —CH₂CHFCF₂CHF₂, —CH₂CHFCF₂CF₃, —OCH₂F, —OCHF₂, —OCF₃, —OCH₂CF₃, —OCHFCF₃, —OCF₂CH₂F, —OCF₂CHF₂, —OCF₂CF₃, —OCH₂CH₂CH₂F, —OCH₂CH₂CHF₂, —OCH₂CH₂CF₃, —OCH₂CHFCH₃, —OCH₂CHFCH₂F, —OCH₂CHFCHF₂, —OCH₂CHFCF₃, —OCH₂CF₂CH₃, —OCH₂CF₂CH₂F, —OCH₂CF₂CHF₂, —OCH₂CF₂CF₃, —OCHFCF₂CH₂F, —OCHFCF₂CHF₂, —OCHFCF₂CF₃, —OCH₂CH₂CH₂CF₃, —OCH₂CH₂CHFCH₂F, —OCH₂CH₂CHFCHF₂, —OCH₂CH₂CHFCF₃, —OCH₂CH₂CF₂CH₃, —OCH₂CH₂CF₂CH₂F, —OCH₂CH₂CF₂CHF₂, —OCH₂CH₂CF₂CF₃, —OCH₂CHFCF₂CH₃, —OCH₂CHFCF₂CH₂F, —OCH₂CHFCF₂CHF₂ or —OCH₂CHFCF₂CF₃.

According to another embodiment of the present application, the carbonate compound of the formula (II) is selected from the group consisting of the following compounds:

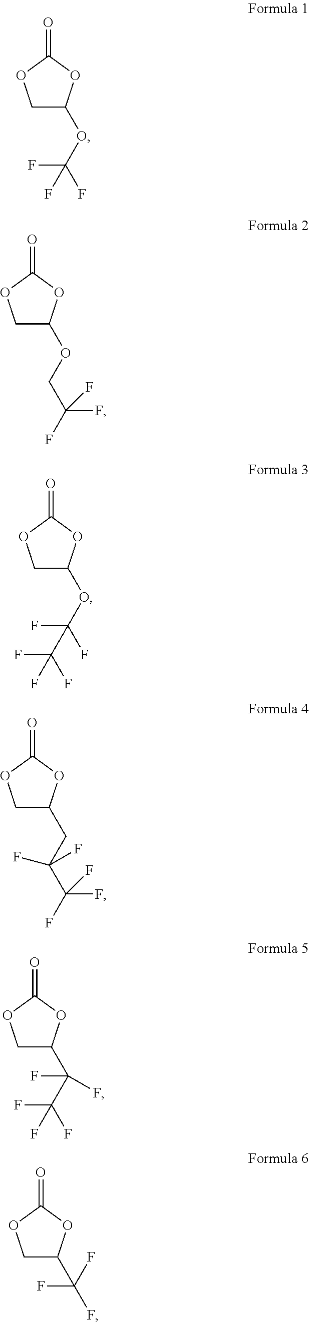

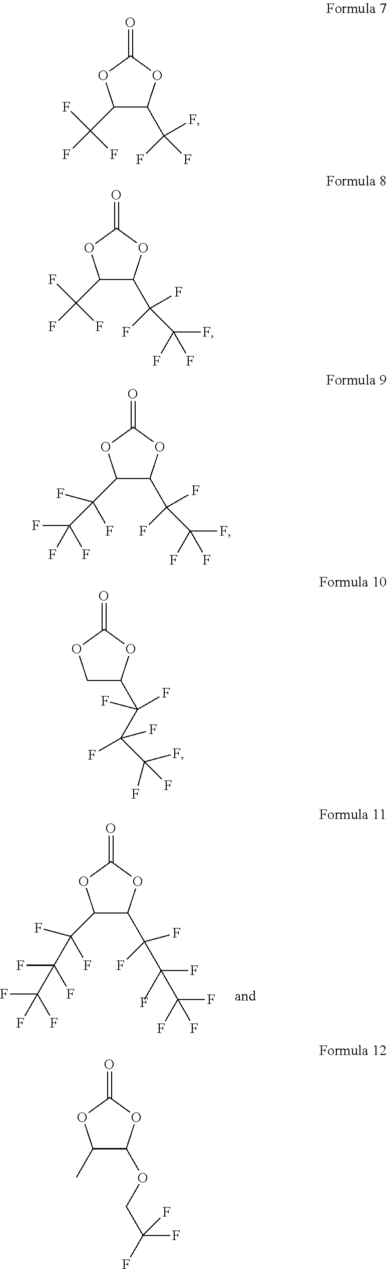

According to yet another embodiment of the present application, the content of the carbonate compound of the formula (II) is about 0.5 wt % to about 30 wt % based on the total weight of the electrolytic solution. Preferably, the content of the carbonate compound of the formula (II) is about 1 wt % to about 25 wt % based on the total weight of the electrolytic solution.

In the electrolytic solution according to a first aspect of the present application, the dinitrile compound is one or a combination of butenedinitrile, pentenedinitrile, hexenedinitrile, heptenedinitrile, octenedinitrile, butanedinitrile, pentanedinitrile, hexanedinitrile, heptanedinitrile and octanedinitrile.

According to still another embodiment of the present application, the dinitrile compound is selected from the group consisting of the following compounds:

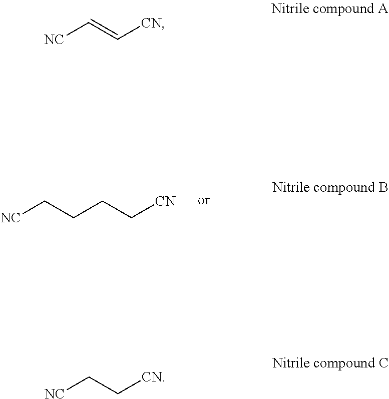 [SMILES: N#C/C=C/C#N ; N#CCCCCC#N ; "or" ; N#CCCC#N]

According to an embodiment of the present application, the trinitrile compound is one or a combination of 1,3,5-pentanetrinitrile, 1,3,5-hexanetrinitrile, 1,3,6-hexanetrinitrile, 1,2,6-hexanetrinitrile, 1,3,7-heptanetrinitrile.

According to another embodiment of the present application, the trinitrile compound is one or a combination of

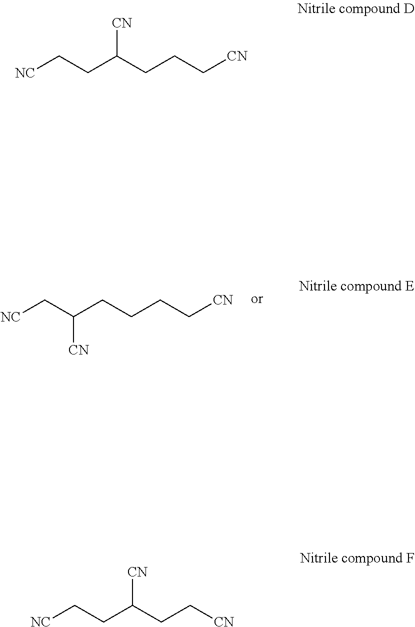 [SMILES: N#CCCCC(C#N)CCC#N ; N#CCCCCC(C#N)CC#N ; "or" ; N#CCCC(C#N)CCC#N]

According to yet another embodiment of the present application, the content of the nitrile compound is about 0.5 wt % to about 10.0 wt % based on the total weight of the electrolytic solution. Preferably, the content of the nitrile compound is about 1 wt % to about 8.0 wt % based on the total weight of the electrolytic solution.

In an embodiment, the electrolytic solution of the present application may further comprise an additive selected from the group consisting of vinylene carbonate (VC), 1,3-propane sultone, ethyl methyl carbonate (EMC), γ-butyrolactone (BL), dioxolane, tetrahydrofuran, and a combination thereof.

In an embodiment, the electrolytic solution of the present application further comprises an organic solvent selected from the group consisting of ethylene carbonate (EC), propylene carbonate (PC), diethyl carbonate (DEC), ethyl propionate (EP), propyl propionate (PP), propyl acetate (PA), ethyl acetate (EA) and a combination thereof. Preferably, the organic solvent is selected from the group consisting of ethylene carbonate (EC), propylene carbonate (PC), diethyl carbonate (DEC), and a combination thereof.

According to an embodiment of the present application, the organic solvent is a combination with the following mass ratios and species: ethylene carbonate (EC):propylene carbonate (PC):diethyl carbonate (DEC)=1:2:6, EC:PC:DEC=1:1:7, EC:PC:DEC=1:7:1, EC:PC:DEC=1:4:4, EC:PC:DEC=2:1:6, PC:DEC=2:7, or EC:DEC=1:8. Preferably, the organic solvent is a combination of EC:PC:DEC=1:2:6.

In an embodiment, the electrolytic solution of the present application further comprises a lithium salt selected from the group consisting of lithium hexafluorophosphate (LiPF₆), lithium tetrafluoroborate (LiBF₄), lithium methanesulfonate (LiCH₃SO₃), lithium trifluoromethanesulfonate (LiCF₃SO₃), lithium hexafluoroarsenate (LiAsF₆), lithium hexafluoroantimonate (LiSbF₆), lithium perchlorate (LiClO₄), Li[BF₂(C₂O₄)], Li[PF₂(C₂O₄)₂], Li[N(CF₃SO₂)₂], Li[C(CF₃SO₂)₃], lithium difluoro(oxalato)borate (LiODFB), lithium bis(oxalate)borate (LiBOB), lithium difluorophosphate (LiPO₂F₂), lithium bis(fluorosulfonyl)imide (LiFSI), lithium bis(trifluoromethanesulfonyl)imide (LiTFSI), and a combination thereof. Preferably, the lithium salt is selected from the group consisting of lithium hexafluorophosphate (LiPF₆), lithium tetrafluoroborate (LiBF₄), and a combination thereof.

According to an embodiment of the present application, the concentration of the lithium salt is about 0.5 mol/L to about 3 mol/L. Preferably, the concentration of the lithium salt is about 0.8 mol/L to about 2 mol/L.

In a second aspect of the present application, the present application provides a lithium ion battery comprising a cathode material, a separator, an anode material and a battery electrolytic solution according to the first aspect of the present application.

According to an embodiment of the present application, the cathode material is selected from the group consisting of lithium cobaltate (LiCoO₂), lithium nickel manganese cobalt ternary material, lithium iron phosphate (LiFePO₄), lithium manganate (LiMn₂O₄), lithium nickelate (LiNiO₂), phosphomolybdic acid (LiMnO₂), lithium cobalt phosphate (LiCoPO₄), lithium molybdenum phosphate (LiMnPO₄), and a combination thereof.

According to another embodiment of the present application, the anode material is at least one selected from the group consisting of silicon or carbon.

According to yet another embodiment of the present application, the separator is selected from the group consisting of polyethylene (PE), polypropylene (PP), PE/PP composite film, nonwoven fabric (polyethylene terephthalate, PET), polyimide (PI), organic-inorganic blend film, aramid film, and a combination thereof.

A lithium ion battery anode material undergoes lithium intercalation reaction during charging, which leads to volume expansion of the material, further causing the problems of deformation of the battery, breaking of the material, powder drop and conductivity deterioration. Some organic solvents are prone to redox reactions during charging and discharging of the lithium ion battery, resulting in electrolytic solution consumption and gas production. The organic solvent carbonate has a stable electrochemical window, has good solubility for lithium salts, can achieve a suitable viscosity, and thus, can provide an efficient medium for lithium ion transfer.

The present application combines additives having film forming effects to prepare the lithium ion battery electrolytic solution. The electrolytic solution includes an organic solvent, additives and a lithium salt, wherein the additives of the carbonate compound of the formula (I) and the carbonate compound of the formula (II) of the present application has a high reduction potential and can stably form an SEI film on the anode during charging, thereby preventing the anode material particles from breaking, inhibiting the decomposition of other components of the electrolytic solution on the surface of the anode, and reducing the generation of by-products. In addition, the nitrile compound of the formulae (III)-(V) can form a stable solid electrolyte film on the surface of the cathode during charging and discharging, thereby inhibiting the oxidative decomposition of the cathode and reducing the generation of by-products. Therefore, the electrolytic solution containing such a specific additive combination not only exhibits good cycle performance during charging and discharging, but also has good storage, floating charge, and nail penetration performance.

Compared with the prior art, the lithium ion battery composed of the anode material and the organic electrolytic solution provided by the present application has the advantages that the electrolytic solution has good thermal stability and film forming effect, can maintain the structural integrity of the anode material during charging and discharging, has good cycle and storage performance at higher voltage and higher temperature, and has good floating charge and nail penetration performance.

### EMBODIMENTS

The technical solution of the present application is further described below with reference to the embodiments, but is not limited thereto. Modifications or equivalents to the technical solution of the present application without departing from the scope of the technical solution of the present application shall all fall within the scope of the present application.

(1) Preparation of Cathode

The cathode active material lithium cobaltate (LiCoO₂), conductive carbon black (Super P), polyvinylidene fluoride (CMC) and N-methylpyrrolidone (NMP) were mixed in a weight ratio of 97.9:1.2:0.5:0.4, and stirred uniformly to obtain a cathode slurry. The slurry was uniformly coated on a cathode current collector (aluminum foil) and dried at 80° C. to obtain the cathode.

(2) Preparation of anode Anode 1: a silicon-containing anode active material, conductive carbon black (Super P) and an adhesive styrene-butadiene rubber (SBR) were mixed in a weight ratio of 95:1:4, and deionized water was added and stirred uniformly to obtain an anode slurry. The slurry was uniformly coated on an anode current collector (copper foil) and dried at 80° C. to obtain the anode.

Anode 2: the preparation method of the anode 2 is similar to that of the anode 1, except that the anode active material is graphite.

(3) Preparation of Electrolytic Solution

In a dry argon atmosphere, different solvents were first uniformly mixed in a certain mass ratio, and different types and concentrations of additives were added on such basis and dissolved uniformly to obtain the electrolytic solution. The specific types and contents of the additives used in the electrolytic solution are shown in Table 1. In Table 1, the content of the additive is a mass percentage calculated based on the total mass of the electrolytic solution.

The solvent ratio of the electrolytic solution is:

Solvent 1: EC+PC+DEC (in a mass ratio of 1:2:6)

Concentration of lithium salt:

Lithium salt 1: LiPF₆=1.15 mol/L;

Lithium salt 2: LiPF₆=3 mol/L;

Lithium salt 3: LiPF₆=0.5 mol/L;

Lithium salt 4: LiPF₆=0.9 mol/L, LiBF₄=0.25 mol/L;

Lithium salt 5: LiPF₆=0.8 mol/L, LiBF₄=0.35 mol/L;

(4) Preparation of Lithium Ion Battery

The cathode, the separator and the anode were stacked in order so that the separator was located between the cathode and the anode, then the stacked sheets and the separator were rolled into a cell, the top side was sealed, the cell was filled with the electrolytic solution, and after the cell was processed, the prepared lithium ion battery was obtained.

The anode of the lithium ion battery of Embodiments 1-69 and Comparative Embodiments 1-16 is the anode 1;

The anode of the lithium ion battery of Embodiments 70-71 and Comparative Embodiments 17-19 is the anode 2.

The lithium ion batteries of Embodiments 1-71 and Comparative Embodiments 1-19 were tested for cycle performance. The specific test methods are as follows:

At 25° C., the battery was charged at a constant current of 0.5 C to a voltage of 4.45 V, charged at a constant voltage to a current of 0.05C, allowed to stand for 5 min, then discharged at a constant current of 0.5 C to a voltage of 3.0 V, and allowed to stand for 5 min, the above being a charge and discharge cycle. When the capacity of the first discharge was 100%, the charge and discharge cycle was repeated, and when the discharge capacity was attenuated to 80%, the test was stopped, and the number of cycles was recorded as an index for evaluating the cycle performance of the lithium ion battery.

At the same time, the cycle performance of the lithium ion battery at 45° C. was tested, and the test method was the same as the above 25° C. cycle performance test.

The lithium ion batteries of Embodiments 1-71 and Comparative Embodiments 1-19 were tested for storage performance. The specific test methods are as follows:

First, a 25° C. capacity test was performed. The battery was charged at a constant current of 0.5C to a voltage of 4.45V, and charged at a constant voltage to a current of 0.05C. The battery was discharged at a constant current of 0.5C to 2.75V. The initial capacity was recorded. Then, the battery was fully charged. The battery was charged at a constant current of 0.5C to 4.45V, and charged at a constant voltage to 0.05C. The cell thickness was recorded under full charge conditions. The battery was stored at 60° C. for 21 days, and the cell thickness was tested every 3 days. The battery was tested for residual capacity, and discharged at a constant current of 0.5C to 2.75V. The discharge capacity was recorded. The 25° C. capacity restoration was tested. The battery was charged at a constant current of 0.5C to 4.45V, and charged at a constant voltage to 0.05C. The battery was allowed to stand for 3 min. The battery was discharged at a constant current of 0.5C to 2.75V.

The lithium ion batteries of Embodiments 1-71 and Comparative Embodiments 1-19 were tested for nail penetration performance. The specific test methods are as follows:

The lithium ion battery was charged at a constant current of 0.5C to 4.45V, charged at a constant voltage to 0.05C and charged to 100% state of charge (SoC). At 25±5° C., under the conditions that the nail diameter was 4 mm and the penetration speed was 30 mm/s, the nail penetration test was performed. The test was passed if the battery did not burn or ignite during the test.

TABLE 1

| | | | Carbonate | | Carbonate | | | | | | | Nail |
|---|---|---|---|---|---|---|---|---|---|---|---|---|
| | | | Compound of | | Compound of | | | | 25° C. | 45° C. | 60° C. | Penetration |
| | | | Formula (I) | | Formula (II) | | Nitrile Compound | | Number | Number | Storage | Test Pass |
| | | Lithium | | Content | | Content | | Content | of | of | Swelling | Number/ |
| No. | Solvent | Salt | Type | wt % | Type | wt % | Type | wt % | Cycles | Cycles | (%) | Total |
| Embodiment 1 | Solvent 1 | Lithium | FEC | 10 | Formula 1 | 10 | Nitrile | 2 | 896 | 884 | 2.63 | 10/10 |
| | | Salt 1 | | | | | Compound D | | | | | |
| Embodiment 2 | Solvent 1 | Lithium | DFEC | 10 | Formula 1 | 10 | Nitrile | 2 | 889 | 877 | 2.31 | 9/10 |
| | | Salt 1 | | | | | Compound D | | | | | |
| Embodiment 3 | Solvent 1 | Lithium | TFEC | 10 | Formula 1 | 10 | Nitrile | 2 | 887 | 869 | 3.92 | 9/10 |
| | | Salt 1 | | | | | Compound D | | | | | |
| Embodiment 4 | Solvent 1 | Lithium | FEC | 10 | Formula 2 | 10 | Nitrile | 2 | 883 | 871 | 3.57 | 9/10 |
| | | Salt 1 | | | | | Compound D | | | | | |
| Embodiment 5 | Solvent 1 | Lithium | FEC | 10 | Formula 3 | 10 | Nitrile | 2 | 861 | 850 | 6.04 | 8/10 |
| | | Salt 1 | | | | | Compound D | | | | | |
| Embodiment 6 | Solvent 1 | Lithium | FEC | 10 | Formula 4 | 10 | Nitrile | 2 | 878 | 832 | 6.79 | 8/10 |
| | | Salt 1 | | | | | Compound D | | | | | |
| Embodiment 7 | Solvent 1 | Lithium | FEC | 10 | Formula 5 | 10 | Nitrile | 2 | 876 | 865 | 5.23 | 8/10 |
| | | Salt 1 | | | | | Compound D | | | | | |
| Embodiment 8 | Solvent 1 | Lithium | FEC | 10 | Formula 1 | 10 | Nitrile | 2 | 792 | 785 | 8.19 | 7/10 |
| | | Salt 2 | | | | | Compound D | | | | | |
| Embodiment 9 | Solvent 1 | Lithium | FEC | 10 | Formula 1 | 10 | Nitrile | 2 | 812 | 805 | 7.74 | 7/10 |
| | | Salt 3 | | | | | Compound D | | | | | |
| Embodiment | Solvent 1 | Lithium | FEC | 10 | Formula 1 | 10 | Nitrile | 2 | 852 | 841 | 6.68 | 8/10 |
| 10 | | Salt 4 | | | | | Compound D | | | | | |
| Embodiment | Solvent 1 | Lithium | FEC | 10 | Formula 1 | 10 | Nitrile | 2 | 878 | 861 | 4.92 | 8/10 |
| 11 | | Salt 5 | | | | | Compound D | | | | | |
| Embodiment | Solvent 1 | Lithium | FEC | 10 | Formula 2 | 10 | Nitrile | 2 | 873 | 853 | 5.15 | 8/10 |
| 12 | | Salt 1 | | | | | Compound F | | | | | |
| Embodiment | Solvent 1 | Lithium | FEC | 10 | Formula 3 | 10 | Nitrile | 2 | 855 | 845 | 6.84 | 7/10 |
| 13 | | Salt 4 | | | | | Compound D | | | | | |
| Embodiment | Solvent 1 | Lithium | FEC | 10 | Formula 4 | 10 | Nitrile | 2 | 827 | 813 | 7.06 | 7/10 |
| 14 | | Salt 4 | | | | | Compound D | | | | | |
| Embodiment | Solvent 1 | Lithium | FEC | 10 | Formula 5 | 10 | Nitrile | 2 | 866 | 865 | 7.03 | 8/10 |
| 15 | | Salt 4 | | | | | Compound D | | | | | |
| Embodiment | Solvent 1 | Lithium | FEC | 10 | Formula 1 | 10 | Nitrile | 2 | 812 | 804 | 7.92 | 7/10 |
| 16 | | Salt 1 | | | | | Compound A | | | | | |
| Embodiment | Solvent 1 | Lithium | FEC | 10 | Formula 1 | 10 | Nitrile | 2 | 843 | 830 | 7.25 | 8/10 |
| 17 | | Salt 1 | | | | | Compound B | | | | | |
| Embodiment | Solvent 1 | Lithium | FEC | 30 | Formula 1 | 10 | Nitrile | 2 | 798 | 782 | 8.12 | 7/10 |
| 18 | | Salt 1 | | | | | Compound D | | | | | |
| Embodiment | Solvent 1 | Lithium | FEC | 25 | Formula 1 | 10 | Nitrile | 2 | 845 | 827 | 6.82 | 8/10 |
| 19 | | Salt 1 | | | | | Compound D | | | | | |
| Embodiment | Solvent 1 | Lithium | FEC | 20 | Formula 1 | 10 | Nitrile | 2 | 856 | 836 | 4.62 | 8/10 |
| 20 | | Salt 1 | | | | | Compound D | | | | | |
| Embodiment | Solvent 1 | Lithium | FEC | 15 | Formula 1 | 10 | Nitrile | 2 | 872 | 860 | 3.98 | 9/10 |
| 21 | | Salt 1 | | | | | Compound D | | | | | |
| Embodiment | Solvent 1 | Lithium | FEC | 1 | Formula 1 | 10 | Nitrile | 2 | 875 | 868 | 3.78 | 9/10 |
| 22 | | Salt 1 | | | | | Compound D | | | | | |
| Embodiment | Solvent 1 | Lithium | FEC | 3 | Formula 1 | 10 | Nitrile | 2 | 880 | 871 | 3.28 | 9/10 |
| 23 | | Salt 1 | | | | | Compound D | | | | | |
| Embodiment | Solvent 1 | Lithium | DFEC | 15 | Formula 1 | 10 | Nitrile | 2 | 896 | 882 | 2.54 | 10/10 |
| 24 | | Salt 1 | | | | | Compound D | | | | | |
| Embodiment | Solvent 1 | Lithium | TFEC | 5 | Formula 1 | 10 | Nitrile | 2 | 885 | 867 | 3.71 | 9/10 |
| 25 | | Salt 1 | | | | | Compound D | | | | | |
| Embodiment | Solvent 1 | Lithium | DFEC | 5 | Formula 1 | 10 | Nitrile | 2 | 874 | 860 | 2.55 | 10/10 |
| 26 | | Salt 1 | | | | | Compound D | | | | | |
| Embodiment | Solvent 1 | Lithium | FEC | 10 | Formula 1 | 10 | Nitrile | 2 | 837 | 820 | 7.41 | 7/10 |
| 27 | | Salt 1 | | | | | Compound C | | | | | |
| Embodiment | Solvent 1 | Lithium | DFEC | 10 | Formula 1 | 10 | Nitrile | 2 | 867 | 855 | 5.35 | 8/10 |
| 28 | | Salt 1 | | | | | Compound C | | | | | |
| Embodiment | Solvent 1 | Lithium | TFEC | 10 | Formula 1 | 10 | Nitrile | 2 | 886 | 872 | 3.08 | 9/10 |
| 29 | | Salt 1 | | | | | Compound C | | | | | |
| Embodiment | Solvent 1 | Lithium | FEC | 5 | Formula 3 | 10 | Nitrile | 2 | 863 | 851 | 6.41 | 9/10 |
| 30 | | Salt 1 | | | | | Compound D | | | | | |
| Embodiment | Solvent 1 | Lithium | FEC | 0.5 | Formula 4 | 10 | Nitrile | 2 | 782 | 773 | 8.47 | 7/10 |
| 31 | | Salt 1 | | | | | Compound D | | | | | |
| Embodiment | Solvent 1 | Lithium | FEC | 15 | Formula 5 | 10 | Nitrile | 2 | 882 | 877 | 2.31 | 10/10 |
| 32 | | Salt 1 | | | | | Compound D | | | | | |
| Embodiment | Solvent 1 | Lithium | FEC | 15 | Formula 2 | 10 | Nitrile | 2 | 872 | 862 | 2.84 | 10/10 |
| 33 | | Salt 1 | | | | | Compound D | | | | | |
| Embodiment | Solvent 1 | Lithium | DFEC | 10 | Formula 2 | 10 | Nitrile | 2 | 887 | 875 | 2.20 | 10/10 |
| 34 | | Salt 1 | | | | | Compound F | | | | | |
| Embodiment | Solvent 1 | Lithium | FEC | 10 | Formula 1 | 0.5 | Nitrile | 2 | 786 | 777 | 8.24 | 7/10 |
| 35 | | Salt 1 | | | | | Compound D | | | | | |
| Embodiment | Solvent 1 | Lithium | FEC | 10 | Formula 1 | 1 | Nitrile | 2 | 843 | 831 | 6.90 | 8/10 |
| 36 | | Salt 1 | | | | | Compound D | | | | | |
| Embodiment | Solvent 1 | Lithium | FEC | 10 | Formula 1 | 3 | Nitrile | 2 | 866 | 851 | 5.93 | 8/10 |
| 37 | | Salt 1 | | | | | Compound D | | | | | |
| Embodiment | Solvent 1 | Lithium | FEC | 10 | Formula 1 | 5 | Nitrile | 2 | 875 | 866 | 5.60 | 8/10 |
| 38 | | Salt 1 | | | | | Compound D | | | | | |
| Embodiment | Solvent 1 | Lithium | FEC | 10 | Formula 1 | 15 | Nitrile | 2 | 895 | 887 | 1.92 | 10/10 |
| 39 | | Salt 1 | | | | | Compound D | | | | | |
| Embodiment | Solvent 1 | Lithium | FEC | 10 | Formula 1 | 20 | Nitrile | 2 | 875 | 870 | 3.15 | 9/10 |
| 40 | | Salt 1 | | | | | Compound D | | | | | |
| Embodiment | Solvent 1 | Lithium | FEC | 10 | Formula 1 | 25 | Nitrile | 2 | 855 | 843 | 4.15 | 8/10 |
| 41 | | Salt 1 | | | | | Compound D | | | | | |
| Embodiment | Solvent 1 | Lithium | FEC | 10 | Formula 1 | 30 | Nitrile | 2 | 827 | 816 | 7.35 | 7/10 |
| 42 | | Salt 1 | | | | | Compound D | | | | | |
| Embodiment | Solvent 1 | Lithium | FEC | 10 | Formula 2 | 0.5 | Nitrile | 2 | 817 | 810 | 7.72 | 7/10 |
| 43 | | Salt 1 | | | | | Compound D | | | | | |
| Embodiment | Solvent 1 | Lithium | FEC | 10 | Formula 3 | 0.5 | Nitrile | 2 | 822 | 814 | 7.78 | 7/10 |
| 44 | | Salt 1 | | | | | Compound D | | | | | |
| Embodiment | Solvent 1 | Lithium | FEC | 10 | Formula 4 | 0.5 | Nitrile | 2 | 831 | 821 | 7.82 | 7/10 |
| 45 | | Salt 1 | | | | | Compound D | | | | | |
| Embodiment | Solvent 1 | Lithium | FEC | 10 | Formula 1 | 10 | Nitrile | 2 | 888 | 870 | 5.04 | 8/10 |
| 46 | | Salt 1 | | | | | Compound F | | | | | |
| Embodiment | Solvent 1 | Lithium | FEC | 10 | Formula 1 | 15 | Nitrile | 2 | 880 | 871 | 4.38 | 9/10 |
| 47 | | Salt 1 | | | | | Compound B | | | | | |
| Embodiment | Solvent 1 | Lithium | FEC | 10 | Formula 1 | 15 | Nitrile | 2 | 872 | 870 | 5.76 | 8/10 |
| 48 | | Salt 1 | | | | | Compound C | | | | | |
| Embodiment | Solvent 1 | Lithium | FEC | 10 | Formula 1 | 15 | Nitrile | 2 | 883 | 872 | 4.26 | 9/10 |
| 49 | | Salt 1 | | | | | Compound F | | | | | |
| Embodiment | Solvent 1 | Lithium | TFEC | 10 | Formula 1 | 15 | Nitrile | 2 | 890 | 885 | 3.22 | 9/10 |
| 50 | | Salt 1 | | | | | Compound D | | | | | |
| Embodiment | Solvent 1 | Lithium | FEC | 10 | Formula 2 | 15 | Nitrile | 2 | 879 | 868 | 4.78 | 8/10 |
| 51 | | Salt 1 | | | | | Compound D | | | | | |
| Embodiment | Solvent 1 | Lithium | FEC | 10 | Formula 2 | 5 | Nitrile | 2 | 855 | 847 | 5.50 | 8/10 |
| 52 | | Salt 1 | | | | | Compound D | | | | | |
| Embodiment | Solvent 1 | Lithium | FEC | 10 | Formula 2 | 20 | Nitrile | 2 | 871 | 861 | 5.47 | 8/10 |
| 53 | | Salt 1 | | | | | Compound D | | | | | |
| Embodiment | Solvent 1 | Lithium | FEC | 10 | Formula 3 | 10 | Nitrile | 2 | 874 | 865 | 5.48 | 8/10 |
| 54 | | Salt 1 | | | | | Compound F | | | | | |
| Embodiment | Solvent 1 | Lithium | FEC | 15 | Formula 3 | 10 | Nitrile | 2 | 857 | 849 | 6.27 | 8/10 |
| 55 | | Salt 1 | | | | | Compound D | | | | | |
| Embodiment | Solvent 1 | Lithium | FEC | 10 | Formula 1 | 10 | Nitrile | 1 | 835 | 827 | 7.19 | 7/10 |
| 56 | | Salt 1 | | | | | Compound D | | | | | |
| Embodiment | Solvent 1 | Lithium | FEC | 10 | Formula 1 | 10 | Nitrile | 3 | 878 | 867 | 4.98 | 9/10 |
| 57 | | Salt 1 | | | | | Compound D | | | | | |
| Embodiment | Solvent 1 | Lithium | FEC | 10 | Formula 1 | 10 | Nitrile | 7 | 845 | 837 | 6.92 | 8/10 |
| 58 | | Salt 1 | | | | | Compound D | | | | | |
| Embodiment | Solvent 1 | Lithium | FEC | 10 | Formula 1 | 10 | Nitrile | 5 | 886 | 867 | 3.12 | 9/10 |
| 59 | | Salt 1 | | | | | Compound D | | | | | |
| Embodiment | Solvent 1 | Lithium | FEC | 10 | Formula 1 | 10 | Nitrile | 10 | 825 | 817 | 8.92 | 7/10 |
| 60 | | Salt 1 | | | | | Compound D | | | | | |
| Embodiment | Solvent 1 | Lithium | FEC | 10 | Formula 1 | 10 | Nitrile | 3 | 871 | 860 | 5.98 | 8/10 |
| 61 | | Salt 1 | | | | | Compound F | | | | | |
| Embodiment | Solvent 1 | Lithium | FEC | 10 | Formula 1 | 10 | Nitrile | 5 | 858 | 850 | 6.14 | 8/10 |
| 62 | | Salt 1 | | | | | Compound C | | | | | |
| Embodiment | Solvent 1 | Lithium | FEC | 10 | Formula 1 | 10 | Nitrile | 5 | 862 | 854 | 5.87 | 8/10 |
| 63 | | Salt 1 | | | | | Compound B | | | | | |
| Embodiment | Solvent 1 | Lithium | TFEC | 10 | Formula 1 | 10 | Nitrile | 5 | 872 | 861 | 5.72 | 8/10 |
| 64 | | Salt 1 | | | | | Compound F | | | | | |
| Embodiment | Solvent 1 | Lithium | FEC | 10 | Formula 2 | 10 | Nitrile | 5 | 860 | 851 | 5.94 | 8/10 |
| 65 | | Salt 1 | | | | | Compound B | | | | | |
| Embodiment | Solvent 1 | Lithium | FEC | 10 | Formula 3 | 10 | Nitrile | 5 | 857 | 841 | 6.38 | 8/10 |
| 66 | | Salt 1 | | | | | Compound B | | | | | |
| Embodiment | Solvent 1 | Lithium | FEC | 10 | Formula 4 | 10 | Nitrile | 5 | 851 | 842 | 6.27 | 8/10 |
| 67 | | Salt 1 | | | | | Compound B | | | | | |
| Embodiment | Solvent 1 | Lithium | TFEC | 10 | Formula 1 | 10 | Nitrile | 5 | 890 | 879 | 2.75 | 9/10 |
| 68 | | Salt 1 | | | | | Compound B | | | | | |
| Embodiment | Solvent 1 | Lithium | DFEC | 10 | Formula 1 | 15 | Nitrile | 5 | 893 | 878 | 2.24 | 10/10 |
| 69 | | Salt 1 | | | | | Compound B | | | | | |
| Embodiment | Solvent 1 | Lithium | FEC | 1 | Formula 1 | 1 | Nitrile | 2 | 862 | 849 | 5.97 | 8/10 |
| 70 | | Salt 1 | | | | | Compound D | | | | | |
| Embodiment | Solvent 1 | Lithium | FEC | 0.8 | Formula 1 | 1 | Nitrile | 2 | 856 | 842 | 6.07 | 8/10 |
| 71 | | Salt 1 | | | | | Compound D | | | | | |
| Comparative | Solvent 1 | Lithium | — | 0 | Formula 1 | 10 | Nitrile | 2 | 703 | 691 | 10.45 | 6/10 |
| Embodiment 1 | | Salt 1 | | | | | Compound C | | | | | |
| Comparative | Solvent 1 | Lithium | — | 0 | Formula 1 | 10 | Nitrile | 2 | 707 | 698 | 10.13 | 6/10 |
| Embodiment 2 | | Salt 1 | | | | | Compound B | | | | | |
| Comparative | Solvent 1 | Lithium | — | 0 | Formula 1 | 10 | Nitrile | 2 | 719 | 707 | 10.12 | 6/10 |
| Embodiment 3 | | Salt 1 | | | | | Compound D | | | | | |
| Comparative | Solvent 1 | Lithium | FEC | 0.1 | Formula 1 | 10 | Nitrile | 2 | 721 | 712 | 10.03 | 7/10 |
| Embodiment 4 | | Salt 1 | | | | | Compound C | | | | | |
| Comparative | Solvent 1 | Lithium | FEC | 35 | Formula 1 | 10 | Nitrile | 2 | 698 | 687 | 13.92 | 6/10 |
| Embodiment 5 | | Salt 1 | | | | | Compound C | | | | | |
| Comparative | Solvent 1 | Lithium | FEC | 10 | — | 0 | Nitrile | 2 | 684 | 670 | 15.98 | 6/10 |
| Embodiment 6 | | Salt 1 | | | | | Compound B | | | | | |
| Comparative | Solvent 1 | Lithium | FEC | 10 | — | 0 | Nitrile | 2 | 688 | 68 | 15.03 | 6/10 |
| Embodiment 7 | | Salt 1 | | | | | Compound C | | | | | |
| Comparative | Solvent 1 | Lithium | FEC | 10 | — | 0 | Nitrile | 2 | 702 | 698 | 11.25 | 6/10 |
| Embodiment 8 | | Salt 1 | | | | | Compound D | | | | | |
| Comparative | Solvent 1 | Lithium | FEC | 10 | Formula 1 | 0.1 | Nitrile | 2 | 681 | 661 | 16.12 | 6/10 |
| Embodiment 9 | | Salt 1 | | | | | Compound C | | | | | |
| Comparative | Solvent 1 | Lithium | FEC | 10 | Formula 1 | 0.1 | Nitrile | 2 | 701 | 697 | 12.65 | 6/10 |
| Embodiment | | Salt 1 | | | | | Compound D | | | | | |
| 10 | | | | | | | | | | | | |
| Comparative | Solvent 1 | Lithium | FEC | 10 | Formula 2 | 0.1 | Nitrile | 2 | 700 | 695 | 13.11 | 6/10 |
| Embodiment | | Salt 1 | | | | | Compound D | | | | | |
| 11 | | | | | | | | | | | | |
| Comparative | Solvent 1 | Lithium | FEC | 10 | Formula 1 | 35 | Nitrile | 2 | 693 | 682 | 14.09 | 6/10 |
| Embodiment | | Salt 1 | | | | | Compound C | | | | | |
| 12 | | | | | | | | | | | | |
| Comparative | Solvent 1 | Lithium | FEC | 10 | Formula 1 | 35 | Nitrile | 2 | 702 | 680 | 13.89 | 6/10 |
| Embodiment | | Salt 1 | | | | | Compound D | | | | | |
| 13 | | | | | | | | | | | | |
| Comparative | Solvent 1 | Lithium | FEC | 10 | Formula 1 | 10 | — | 0 | 672 | 668 | 16.53 | 5/10 |
| Embodiment | | Salt 1 | | | | | | | | | | |
| 14 | | | | | | | | | | | | |
| Comparative | Solvent 1 | Lithium | FEC | 10 | Formula 1 | 10 | Nitrile | 0.3 | 688 | 671 | 15.93 | 6/10 |
| Embodiment | | Salt 1 | | | | | Compound D | | | | | |
| 15 | | | | | | | | | | | | |
| Comparative | Solvent 1 | Lithium | FEC | 10 | Formula 1 | 10 | Nitrile | 11 | 680 | 675 | 16.03 | 5/10 |
| Embodiment | | Salt 1 | | | | | Compound D | | | | | |
| 16 | | | | | | | | | | | | |
| Comparative | Solvent 1 | Lithium | — | 0 | Formula 1 | 1 | Nitrile | 2 | 673 | 665 | 16.61 | 5/10 |
| Embodiment | | Salt 1 | | | | | Compound D | | | | | |
| 17 | | | | | | | | | | | | |
| Comparative | Solvent 1 | Lithium | FEC | 1 | — | 0 | Nitrile | 2 | 676 | 669 | 16.53 | 5/10 |
| Embodiment | | Salt 1 | | | | | Compound D | | | | | |
| 18 | | | | | | | | | | | | |
| Comparative | Solvent 1 | Lithium | FEC | 1 | Formula 1 | 1 | — | 0 | 670 | 661 | 16.62 | 5/10 |
| Embodiment | | Salt 1 | | | | | | | | | | |
| 19 | | | | | | | | | | | | |

### Embodiments 1-3, 18-26, 70-71 and Comparative Embodiments 3-5, 17

When comparing Embodiments 1-3 and 18-26 with Comparative Embodiment 3 and comparing Embodiments 70-71 with Comparative Embodiment 17, it was found that compared with the electrolytic solution phase (Comparative Embodiment 3) in which the carbonate compound of the formula (I) is not added, the electrolytic solution in which 0.8 wt %, 1 wt %, 3 wt %, 5 wt %, 10 wt %, 15 wt %, 20 wt %, 25 wt % and 30 wt % of the carbonate compound of the formula (I) is added as an additive can greatly improve the cycle performance of the lithium ion battery. Specifically, the number of cycles is increased by 100 or more, and meanwhile, the storage and nail penetration performance of the lithium ion battery are greatly improved.

When comparing Embodiments 18-26 with Comparative Embodiments 4-5, it was found that the too high or too low content of the carbonate compound of the formula (I) affects the cycle performance, and storage and nail penetration performance of the lithium ion battery. When the content of the carbonate of the formula (I) is too low, it is difficult to completely form a stable SEI on the surface of the anode, and the electrode material and the electrolytic solution cannot be completely protected, resulting in deterioration of the cycle performance of the lithium ion battery, and the degradation in the storage and nail penetration performance. When the content of the carbonate of the formula (1) is too high, the viscosity of the electrolytic solution is increased on the one hand, and on the other hand, the carbonate is easily decomposed to generate a gas, which further affects the cycle, storage and nail penetration performance of the battery.

### Embodiments 1, 4-7, 35-45, 51-53, 70 and Comparative Embodiments 8, 10, 13, 18

When comparing Embodiments 1, 4-7, 35-45 and 51-53 with Comparative Embodiment 8 and comparing Embodiment 70 with Comparative Embodiment 18, it was found that the addition of 0.5 wt %, 1 wt %, 3 wt %, 5 wt %, 10 wt %, 15 wt %, 20 wt % and 30 wt % of the carbonate compound of the formula (II) can greatly improve the cycle performance of the lithium ion battery, and can greatly improve the storage and nail penetration performance of the lithium ion battery.

When comparing Embodiment 1, Embodiments 36-42 and Comparative Embodiments 10 and 13, it was found that the too high or too low content of the carbonate compound of the formula (II) will result in the degradation of the cycle performance, and storage and nail penetration performance of the lithium ion battery. The carbonate compound of the formula (II) has good oxidation resistance and can form a film well on the surface of the anode. When the content is too low, the film formation and the effect of stabilizing the electrolytic solution are not obtained; however, when the content is too high, it will lead to an increase in the viscosity of the electrolytic solution, which is not beneficial to the transport of lithium ions in the electrolytic solution.

### Embodiment 1, 16-17, 27, 46, 56-63, 70 and Comparative Embodiments 14-16

When comparing Embodiments 1, 16-17, 27, 46 and 56-63 with Comparative Embodiment 14 and comparing Embodiment 70 with Comparative Embodiment 19, it was found that the addition of 1 wt %, 2 wt %, 3 wt %, 5 wt %, 7 wt % and 10 wt % of the nitrile compounds of the formula (III), the formula (IV) and the formula (V) can greatly improve the cycle performance of the lithium ion battery, and greatly improve the storage and nail penetration performance of the lithium ion battery at the same time.

As shown in Embodiment 1, Embodiments 56-60, and Comparative Embodiments 15-16, too high or too low nitrile content results in the degradation of the cycle performance, storage and nail penetration performance of the battery. When the nitrile content is too low, the capacity decreases faster during the cycle of the cell. When the nitrile content is too high, the viscosity of the electrolytic solution increases, which degrades reaction kinetics and increases the cathode impedance, such that the polarization of the battery becomes more and more serious during charging and discharging, thereby affecting the cycle life of the battery.

The above description summarizes the features of several embodiments, which will enable those of ordinary skill in the art to understand the various aspects of the present application. Those of ordinary skill in the art can readily take the present application as a basis for designing or modifying other compositions to achieve the same objectives and/or the same advantages as the embodiments herein. It is also to be understood by those of ordinary skill in the art that these equal examples do not depart from the spirit and scope of the present application, and it is possible to make various changes, substitutions and modifications to the present application without departing from the spirit and scope of the present application.

What is claimed is:

1. An electrolytic solution, comprising:
a carbonate compound of the formula (I) 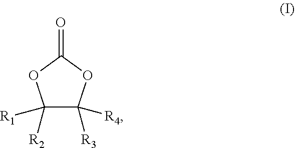
wherein R₁, R₂, R₃ and R₄ are each independently selected from hydrogen or halogen, and at least one of R₁, R₂, R₃ and R₄ is halogen;
a carbonate compound of the formula (II) 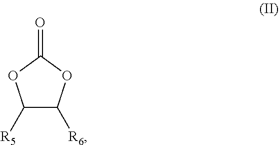
wherein R₅ and R₆ are each independently selected from hydrogen, halogen, (C₁-C₁₀)alkyl, (C₁-C₁₀)haloalkyl, (C₁-C₁₀)alkoxy or (C₁-C₁₀)haloalkoxy, and at least one of R₅ and R₆ is (C₁-C₁₀)haloalkyl or (C₁-C₁₀)haloalkoxy; and
a nitrile compound, the nitrile compound being selected from the group consisting of a dinitrile compound of the formula (III), a dinitrile compound of the formula (IV), a trinitrile compound of the formula (V), and a combination thereof: 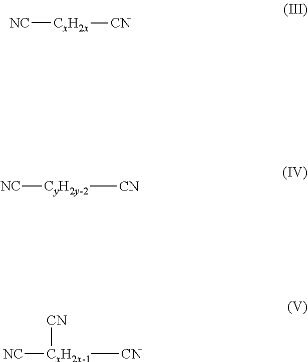
where x is a positive integer from 1 to 10, and y is a positive integer from 2 to 10.

2. The electrolytic solution according to claim 1, wherein in the carbonate compound of the formula (II), R₅ is hydrogen, (C₁-C₆)alkyl or (C₁-C₆)fluoroalkyl; and R₆ is (C₁-C₆)fluoroalkyl or (C₁-C₆)fluoroalkoxy.

3. The electrolytic solution according to claim 1, wherein in the carbonate compound of the formula (II), R₅ is selected from H, F, —CH₃, —CH₂F, —CHF₂, —CF₃, —CH₂CF₃, —CHFCF₃, —CF₂CH₂F, —CF₂CF₃, —CF₂CF₂CF₃, —CF₂CHF₂, —CF₂CF₃—CH₂CH₂CH₂F or —CH₂CH₂CHF₂; and R₆ is selected from —CH₂F, —CHF₂, —CF₃, —CH₂CF₃, —CHFCF₃, —CF₂CH₂F, —CF₂CHF₂, —CF₂CF₃, —CH₂CH₂CH₂F, —CH₂CH₂CHF₂, —CH₂CH₂CF₃, —CH₂CHFCH₃, —CH₂CHFCH₂F, —CH₂CHFCHF₂, —CH₂CHFCF₃, —CH₂CF₂CH₃, —CH₂CF₂CH₂F, —CH₂CF₂CHF₂, —CH₂CF₂CF₃, —CHFCF₂CH₂F, —CHFCF₂CHF₂, —CHFCF₂CF₃, —CF₂CF₂CF₃, —CH₂CH₂CH₂CF₃, —CH₂CH₂CHFCH₂F, —CH₂CH₂CHFCHF₂, —CH₂CH₂CHFCF₃, —CH₂CH₂CF₂CH₃, —CH₂CH₂CF₂CH₂F, —CH₂CH₂CF₂CHF₂, —CH₂CH₂CF₂CF₃, —CH₂CHFCF₂CH₃, —CH₂CHFCF₂CH₂F, —CH₂CHFCF₂CHF₂, —CH₂CHFCF₂CF₃, —OCH₂F, —OCHF₂, —OCF₃, —OCH₂CF₃, —OCHFCF₃, —OCF₂CH₂F, —OCF₂CHF₂, —OCF₂CF₃, —OCH₂CH₂CH₂F, —OCH₂CH₂CHF₂, —OCH₂CH₂CF₃, —OCH₂CHFCH₃, —OCH₂CHFCH₂F, —OCH₂CHFCHF₂, —OCH₂CHFCF₃, —OCH₂CF₂CH₃, —OCH₂CF₂CH₂F, —OCH₂CF₂CHF₂, —OCH₂CF₂CF₃, —OCHFCF₂CH₂F, —OCHFCF₂CHF₂, —OCHFCF₂CF₃, —OCH₂CH₂CH₂CF₃, —OCH₂CH₂CHFCH₂F, —OCH₂CH₂CHFCHF₂, —OCH₂CH₂CHFCF₃, —OCH₂CH₂CF₂CH₃, —OCH₂CH₂CF₂CH₂F, —OCH₂CH₂CF₂CHF₂, —OCH₂CH₂CF₂CF₃, —OCH₂CHFCF₂CH₃, —OCH₂CHFCF₂CH₂F, —OCH₂CHFCF₂CHF₂ or —OCH₂CHFCF₂CF₃.

4. The electrolytic solution according to claim 1, wherein the carbonate compound of the formula (II) is selected from the group consisting of the following compounds:

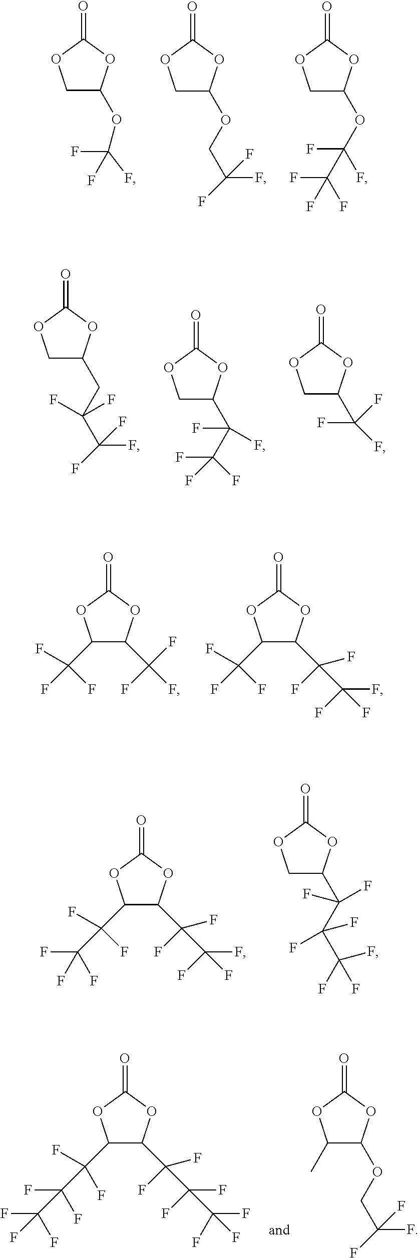

5. The electrolytic solution according to claim 1, wherein the carbonate compound of the formula (I) is selected from the group consisting of fluoroethylene carbonate, 4,5-difluoroethylene carbonate, 4,4,5,5-tetrafluoroethylene carbonate and a combination thereof.

6. The electrolytic solution according to claim 1, wherein the dinitrile compound is selected from the group consisting of butenedinitrile, pentenedinitrile, hexenedinitrile, heptenedinitrile, octenedinitrile, butanedinitrile, pentanedinitrile, hexanedinitrile, heptanedinitrile, octanedinitrile and a combination thereof.

7. The electrolytic solution according to claim 1, wherein the trinitrile compound is selected from the group consisting of 1,3,5-pentanetrinitrile, 1,3,5-hexanetrinitrile, 1,3,6-hexanetrinitrile, 1,2,6-hexanetrinitrile, 1,3,7-heptanetrinitrile and a combination thereof.

8. The electrolytic solution according to claim 1, wherein the content of the carbonate compound of the formula (I) is about 0.5 wt % to about 30 wt % based on the total weight of the electrolytic solution, the content of the carbonate compound of the formula (II) is about 1 wt % to about 30 wt % based on the total weight of the electrolytic solution, and the content of the nitrile compound is about 0.5 wt % to about 10 wt % based on the total weight of the electrolytic solution.

9. The electrolytic solution according to claim 1, further comprising an additive, wherein the additive is selected from the group consisting of vinylene carbonate, 1,3-propane sultone, ethyl methyl carbonate, γ-butyrolactone, dioxolane, tetrahydrofuran, and a combination thereof.

10. The electrolytic solution according to claim 1, further comprising an organic solvent, wherein the organic solvent is selected from the group consisting of ethylene carbonate, propylene carbonate, diethyl carbonate, ethyl propionate, propyl propionate, propyl acetate, ethyl acetate and a combination thereof.

11. The electrolytic solution according to claim 1, further comprising a lithium salt, wherein the lithium salt is selected from the group consisting of lithium hexafluorophosphate, lithium tetrafluoroborate, lithium methanesulfonate, lithium trifluoromethanesulfonate, lithium hexafluoroarsenate, lithium hexafluoroantimonate, lithium perchlorate, Li[PF₂(C₂O₄)₂], Li[N(CF₃SO₂)₂], Li[C(CF₃SO₂)₃], lithium difluoro(oxalato)borate, lithium bis(oxalate)borate, lithium difluorophosphate, lithium bis(fluorosulfonyl)imide, lithium bis(trifluoromethanesulfonyl)imide, and a combination thereof.

12. The electrolytic solution according to claim 11, wherein the concentration of the lithium salt is about 0.5 mol/L to about 3 mol/L.

13. A lithium ion battery, comprising a cathode material, a separator, an anode material, and an electrolytic solution according to claim 1.

14. The lithium ion battery according to claim 13, wherein the electrolytic solution comprises:
a carbonate compound of the formula (I) selected from the group consisting of fluoroethylene carbonate, 4,5-difluoroethylene carbonate, 4,4,5,5-tetrafluoroethylene carbonate and a combination thereof;
a carbonate compound of the formula (II) selected from the group consisting of the following compounds: 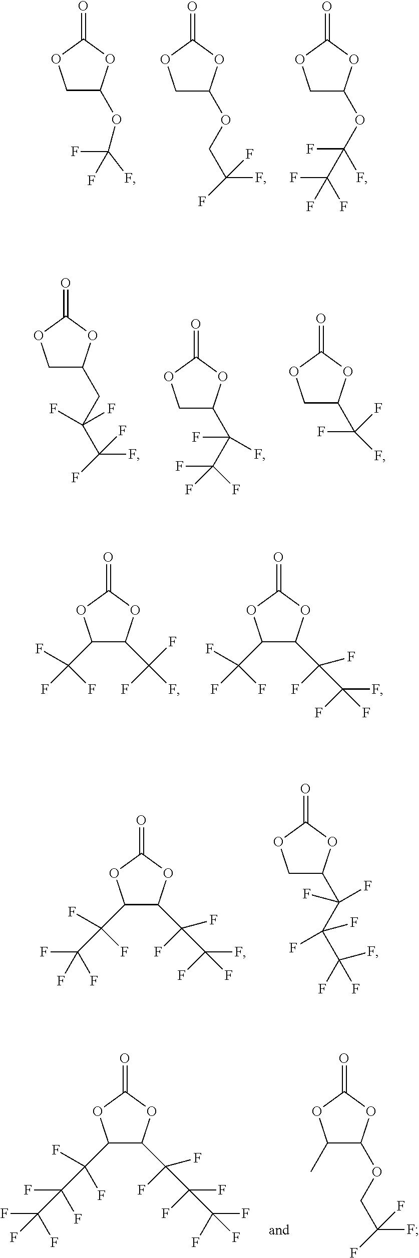
and
a nitrile compound selected from the group consisting of butenedinitrile, pentenedinitrile, hexenedinitrile, heptenedinitrile, octenedinitrile, butanedinitrile, pentanedinitrile, hexanedinitrile, heptanedinitrile, octanedinitrile, 1,3,5-pentanetrinitrile, 1,3,5-hexanetrinitrile, 1,3,6-hexanetrinitrile, 1,2,6-hexanetrinitrile, 1,3,7-heptanetrinitrile and a combination thereof.

15. The lithium ion battery according to claim 14, wherein the content of the carbonate compound of the formula (I) is about 0.5 wt % to about 30 wt % based on the total weight of the electrolytic solution, the content of the carbonate compound of the formula (II) is about 1 wt % to about 30 wt % based on the total weight of the electrolytic solution, and the content of the nitrile compound is about 0.5 wt % to about 10 wt % based on the total weight of the electrolytic solution.

16. The lithium ion battery according to claim 13, wherein the electrolytic solution further comprises an additive selected from the group consisting of vinylene carbonate, 1,3-propane sultone, ethyl methyl carbonate, γ-butyrolactone, dioxolane, tetrahydrofuran, and a combination thereof.

17. The lithium ion battery according to claim 13, wherein the electrolytic solution further comprises a lithium salt selected from the group consisting of lithium hexafluorophosphate, lithium tetrafluoroborate, lithium methanesulfonate, lithium trifluoromethane sulfonate, lithium hexafluoroarsenate, lithium hexafluoroantimonate, lithium perchlorate, Li[PF₂(C₂O₄)₂], Li[N(CF₃SO₂)₂], Li[C(CF₃SO₂)₃], lithium difluoro(oxalato)borate, lithium bis(oxalate)borate, lithium difluorophosphate, lithium bis(fluorosulfonyl)imide, lithium bis(trifluoromethanesulfonyl)imide, and a combination thereof.

18. The lithium ion battery according to claim 13, wherein the cathode material is selected from the group consisting of lithium cobaltate (LiCoO₂), lithium nickel manganese cobalt ternary material, lithium iron phosphate (LiFePO₄), lithium manganate (LiMn₂O₄), lithium nickelate (LiNiO₂), phosphomolybdic acid (LiMnO₂), lithium cobalt phosphate (LiCoPO₄), lithium molybdenum phosphate (LiMnPO₄), and a combination thereof.

19. The lithium ion battery according to claim 13, wherein the separator is selected from the group consisting of polyethylene (PE), polypropylene (PP), PE/PP composite film, nonwoven fabric (polyethylene terephthalate, PET), polyimide (PI), organic-inorganic blend film, aramid film, and a combination thereof.

20. The lithium ion battery according to claim 13, wherein the anode material is at least one selected from silicon or carbon.
